(19) United States
(12) Patent Application Publication
(10) Pub. No.: US 2014/0279166 A1
(43) Pub. Date: Sep. 18, 2014

(54) Method and System for Brokering Shipping Contracts Between Solicitors and Service Providers

(71) Applicant: 3S APPLICATIONS, INC., Vancouver (CA)

(72) Inventors: Tomas Bilik, Jicin (CZ); Jiri Mencl, Sao Paulo (BR)

(73) Assignee: 3S APPLICATIONS, INC., Vancouver (CA)

(21) Appl. No.: 13/803,834

(22) Filed: Mar. 14, 2013

(51) Int. Cl. G06Q 30/06

(52) U.S. Cl. CPC G06Q 30/0611
USPC 705/26.4

(57) ABSTRACT

Method and system for brokering shipping contracts between solicitors and service providers is disclosed. The system comprises a central processing computer distributing requests for shipping service quote from solicitors to solicitors-predefined list of service providers and an interface used to input parameters of the required shipping service, input quote for such service, review all inputted quotes, select the desired quote, register shipping contract based on selected quote, and send and receive contract related communications.

### FIELD OF THE INVENTION

This present invention relates to method and system for brokering shipping contracts, and more particularly, for requesting, receiving, presenting and storing shipping service quotes, registering awarded shipping contracts, and sending and receiving post-awarding communication to facilitate shipping procedures.

### BACKGROUND OF THE INVENTION

With logistics playing a critical role in any sort of local or international trade, product value-chains, private or government organizations globally, the processes and systems employed for engaging shipping services are usually labor intensive and time consuming to operate.

The parties that require shipping service (solicitors) have to contract a shipping company, which is usually a third party (service provider) and determine the cost of the shipping service. Solicitors are contracting service providers for term contracts with ongoing periodic deliveries, or one-off usually urgent (time critical) shipments. The general rule is that solicitors dictate the method of how the shipment should be delivered—by air, sea, or ground—and engage several service providers to determine the best option regarding price and time for delivery.

The shipping process usually involves tasks like compiling a request for quote, obtaining and reviewing quotes, contract awarding and documenting of the contract, and post-awarding shipment updates communications performed with new or already established service providers. While some steps of the process have been partially automated with using modern technologies or some stand-alone solutions, there are no unified process standards for efficiently managing all common shipping tasks. As result, the shipping contracts awarded are not always the most cost-efficient option for given situation, and the process itself is driving logistics personnel costs up and consuming significant amount of time with manual steps on both solicitor and service provider sides.

Additionally, the problems faced by solicitors contracting shipping services are related to heavily relying on assessments and decisions made by logistics managers versus decisions made with help of an automated system allowing transparent comparison of received offers and transparent selection of service providers. The human factor involved in the current process (i.e. face to face or telephonic verbal communication, or written correspondence, between provider personnel and solicitors) decreases capability of making fully unbiased decisions, timely progress and documentation updates and increases chances for various errors.

On the other side, the problem faced by service providers who wish to offer their shipping services is that they are unable to dictate a level of automation to their customer and, as a stand-alone provider, they have no incentive in creating an automated solution for solicitors because that same solution could be also used by other providers working with the same solicitors, thus creating additional competition for the provider.

Therefore, a need exists for a method and system that would allow brokering of a deal for a shipping service contract between a solicitor and a service provider in a time-efficient manner using streamlined standardized formatting to assess and make an unbiased decision, and provide support for post-awarding communications and updates between the parties.

### SUMMARY OF THE INVENTION

Accordingly, the present invention provides a method and system for brokering shipping contracts between solicitors and service providers. A preferred embodiment of the present invention includes: a central processing computer distributing communications between solicitors and service providers; an interface enabled to accept parameters inputted by solicitors and service providers relating to requesting of and providing quotes for a shipping service, awarding of a shipping contract, post-awarding communications, and displaying reports generated by the central processing computer; and a data storage and backup facility for storing parameters previously inputted by solicitors and service providers.

Accordingly to the preferred embodiment of the present invention, the initial step is for solicitors to create a shipping service request for a shipping quote that they submit via communications network to centralized processing computer using a user interface. Additionally, at that point of time the solicitors also use the interface to input information about service providers that they want to receive quotation from. If the solicitor has already used the system previously and inputted information about service providers, the information about the service providers will be already stored in the data storage facility and will be available for the solicitor to include in a distribution list for the service request without re-inputting information about each particular service provider again.

In one embodiment, once the request for the shipping quote is inputted, a communications facilitating system within the centralized processing computer will distribute the request via a communications network to the service providers pre-defined by solicitor, for example sending the request by email using an email address of the provider that was specified by the solicitor. In one embodiment, providers may also be able to set up an account and register with the system on their own, although the benefits of the system wouldn't be realized until a solicitor specifies them as one of the providers from which they wish to receive quotes. The request contains details about the required shipping service and provides an option for the service provider to access the central processing computer via the user interface and input their quote and related shipping details, such as expected delivery time, port of entry (if applicable), and any applicable taxes for the service request. The interface will also show any applicable contracting fees that may be payable by the service provider to the administration entity operating the system. The contracting fees are displayed separately from the quote entered by service provider, at which time service providers can still adjust the quote before submitting it, for example to increase the quote to the solicitor by an amount covering or offsetting the contracting fee payable by the service provider. Once finalized, the received quote from the service provider will be processed by the communication facilitation system and stored in data storage facility. The system will send communication to the solicitor on each new quote submitted by participating service providers.

In one embodiment, upon receiving notification about submitted quotes, the solicitor can access the system via the user interface and review a report displaying all received quotes and respective shipping service details. The interface provides the solicitor with an option to directly and transparently compare received quotes and make an educated decision about the best option in terms of cost, delivery time and other parameters important for the solicitor at the time of decision making.

In one embodiment, the solicitor can select any quote from the report and using same interface to submit a shipping contract award to the service provider of a selected quote. The shipping contracting system records the awarding and stores the update in the data storage facility. The communication facilitation system will distribute notification of the awarded shipping contract to the service provider whose quote was selected, a notification of rejection to each service provider whose quote was not selected and notification of the closing of bidding to the providers who were asked to provide quotation but still had not done so by the time when the contract was awarded.

In one embodiment, after the contract has been awarded to service provider, the service provider will use the user interface to submit shipment processing related information and updates and to upload digital copies of shipment related documentation such as papers for customs clearance, courier passport, proof of delivery, service invoice and other related paperwork that can be later accessed and downloaded by solicitor. The solicitor will also use this interface to provide additional details related to shipment (if any, for example as requested by the service provider). In a case when the solicitor or the awarded service provider submits information to the central processing computer via communications network using other channels other than user interface (for instance by email or SMS text messages), the communication facilitating system may be configured with suitable means to accept communications of this type, and parse or scan their content in order to determine whether the communication includes reference to an unique identification number previously assigned to the awarded contract. Successful identification of this number and matching of same to one of one of the awarded contracts in the system allows the communication to be attached to the respective shipping contract record. If unique identifiers are not matched, the communication will be sent back to the originator using same communication channel that it was received with. All information is processed via communication facilitating system and permanently stored in the data storage facility.

When compared to the existing processes generally used for brokering service contract between the solicitors and service providers, the present invention in the exemplary embodiments handles the process, documentation and all related communications within one non-segregated system, shortens the number of steps taken by solicitors and service providers to broker shipping contract, decreases risk of the solicitor not selecting a lower cost, reduced time or otherwise efficient option, speeds up the contract awarding timeline and saves processing time.

According to one aspect of the invention, there is provided a system for facilitating requesting and receiving of a shipping service quote, by distributing a request from a solicitor to service providers specified by said solicitor via communication network, the system comprising (a) a user interface which enables each of a plurality of solicitors to input parameters for a required shipping service and input information about a plurality of service providers specified by said solicitor, and enables a service provider to input parameters of a quote for the required shipping service; (b) a data storage database for storing the input parameters inputted by the solicitors and a table for the quotes inputted by the service providers; (c) a central processing computer system operating the user interface, connected with the data storage database and configured to (i) receive a solicitor communication from each of the solicitors containing details of the required shipping service; (ii) for each of the solicitors, distribute outgoing communication to the service providers specified thereby, the outgoing communication containing the details of the required shipping service in a quote request; (iii) for each of the solicitors, receive service provider communications from the service providers containing quote details in a quote for the required shipping service; and (iv) for each of the solicitors, generate a report in which the quotes received through the service provider communications are grouped based on the details of the required shipping service previously inputted by the solicitor and distributed by the computer system.

Preferably, the solicitor communication and the service provider communication each contain data fields including (a) a quote request identification number; (b) a type of the requested shipping service; (c) an origin location of the requested shipping service; (d) a destination location of the requested shipping service; (e) a shipment specification; (f) a bidding ending time by which the quotes must be submitted; (g) a pickup date and time; and (h) a delivery date and time; wherein the central processing computer system generates reports with the quote requests and the quotes matched up and grouped in these reports based on at least one of said data fields.

Preferably the solicitor communication contains a unique identification number for that communication and the service provider communication comprises a data field to reference the unique identification number of the solicitor communication and a central processing computer matches the service provider communication and solicitor communication on the basis of unique identification number.

Preferably the details of the required shipping service include fields for (i) shipping service specification and (ii) shipment handling instructions.

Preferably the quote details include fields for (i) estimated delivery time, (ii) total price and (iii) quoting date and time and the report lists said fields for each quote.

Preferably the centralized processing computer system is connected with the data storage database, into which the centralized processing computer system stores the communications from the solicitors and the service providers.

According to another aspect of the invention, there is provided a system for facilitating shipping contract awarding by communicating a contract awarding confirmation from a solicitor to a provider and facilitating post-awarding communications between the solicitor and the provider, the system comprising (a) a data storage database containing contact details previously inputted by the solicitor and contact details previously inputted by service providers; (b) a central processing computer system connected with the data storage database and configured to (i) record a solicitor-awarded contract based on a solicitor-selected quote from among multiple quotes received through communication from different ones of the service providers in response to a quote request from said solicitor; (ii) send notification of the solicitor-awarded contract to a one of the service providers who provided the solicitor-selected quote; (iii) send a notification of rejection to one or more of the service providers who provided a non-selected one of the quotes; (iv) send notification of bid closing to any of the service providers that were included in a list for distribution of the quote request, but did not submit a quote; and (v) receive service provider communication from the one of the service providers who has been awarded the contract, the communication containing updates about the shipping service progress.

Preferably the solicitor communication and the service provider communication each contain the data fields of (a) a communication unique identification number; (b) a quote request identification sequence number; (c) an offered quote identification sequence number; and (d) a contract awarding status; wherein the central processing computer generates reports indicating awarded contracts based on at least those fields.

Preferably the service provider communication contains fields for (i) date and time of delivery, (ii) full name of person who received the shipment and (iii) information about a final invoice for provided shipping service, and the centralized processing computer system distributes the service provider communication to the solicitor.

According to yet another aspect of the invention there is provided a system for executing shipping contracting communications between a solicitor and a service provider comprising (a) client computer hardware and software means to enable the solicitor and the service provider to send and receive communications; (b) means to store data sets of required shipping service parameters and quotes previously and respectively inputted by the solicitor and the service provider; and (c) central computer hardware and software means to (i) receive a solicitor communication from the solicitor containing information about a required shipping service; (ii) distribute communication to service providers containing details of a quote request for the required shipping service; (iii) receive service provider communications from service providers containing quotes for the required shipping service; (iv) match the service provider communications and solicitor communication on the basis of a unique identification number; (v) generate a report in which the quotes received in the service provider communications are grouped based on the details of the quote request previously inputted by the solicitors and distributed by the central computer hardware and software means; (vi) record a solicitor-awarded contract based on selection by the solicitor of one of the quotes received through the service provider communications from the service providers; (vii) send a notification of the solicitor-awarded contract to a one of the service providers whose quote was selected by the solicitor; (viii) send a notification of rejection to one or more of the service providers whose quote was not selected by the solicitor; (ix) send a notification of bid closing to any of the service providers that was included in a list for distribution of the details of the quote request, but did not submit a quote; and (x) receive a post-awarding communication from the one of the service provider who has been awarded the contract, the post-aware communication containing updates about progress of the required shipping service.

According to a further aspect of the invention a method for operating a computer to execute communications necessary for requesting and receiving shipping service quotes and distributing request for shipping service quote from solicitors to service providers, the method comprising the steps of (a) receiving a solicitor communication from a solicitor containing information about a required shipping service; (b) receiving service provider communications from the service providers, each containing details of a quote for the required shipping service; (c) generating a report notification about the received quotes upon completion of a quoting period; (d) sending a confirmation of an awarded contract as a communication to a one of the service providers whose quote was selected by the solicitor; (e) sending a notification of rejection to one or more of the service providers whose quote was not selected by the solicitor; (f) sending a notification of bid closing to at least one service provider that was included in a list for distribution of the quote request, but did not submit a quote; and (g) making available a notification of shipment status and details as a post-awarding communication between the solicitor and the one of the service providers that was awarded the contract.

Preferably there are provided the additional steps of storing the solicitor and service provider communications, and subsequently retrieving said solicitor and service provider communications before attempting to generate the report notification.

According to yet a further aspect of the invention there is provided a method for operating a computer system to execute communications necessary for allocating the cost of contracting fees for shipping contracts awarded by solicitors to the service providers, the method comprising the steps of (a) from an operating entity, receiving configuration parameters of a service plan applied to solicitors who have been assigned different classes, the service plan determining a contracting fee amount to be charged to service provider(s) for a successful quote based at least partly on a respective class of a solicitor who requested the quote; (b) making information about the contracting fee amount available to the service provider for each request for quote, where such information is (i) made available to the service provider upon said service provider reviewing a request for quote received from the solicitor; and (ii) made available prior to the service provider submitting a quote to said solicitor in response to said request for quote.

There may be provided the additional step of allowing the service provider to adjust the quote after reviewing the contracting fee amount and before submitting the quote to the solicitor.

The present invention and its features and advantages will become more apparent from the following detailed description with reference to the accompanying drawings.

### BRIEF DESCRIPTION OF DRAWINGS

FIG. 1—is a block diagram showing a system for brokering shipping contracts between solicitors and service providers according to an exemplary embodiment of the present invention.

FIG. 2—is a flowchart showing an exemplary process flow for requesting and receiving shipping service quotes and registering an awarded contract in the system for brokering shipping contracts between solicitors and service providers.

FIG. 3—is a flowchart showing an exemplary process flow for submitting a shipping service quote and allocating a fee in the system for brokering shipping contracts between solicitors and service providers.

FIG. 4—is a flowchart showing an exemplary process flow for sending and receiving post-awarding communications related to the shipping contract in the system for brokering shipping contracts between solicitors and service providers.

FIG. 5—depicts a database storage structure for Shipping Quoting and Contracting (SQC) information which is employed in the system for brokering shipping contracts between solicitors and service providers.

### DETAILED DESCRIPTION OF THE INVENTION

FIG. 1 shows an overview of an exemplary system for brokering shipping contracts between solicitors and service providers. A Centralized Processing Computer 10 comprises a User Interface and Communications Facilitating System 20 and a Shipping Contracting System 30, having a set of programmed elements that enables each of the parties, solicitor(s) 80 and service provider(s) 90 to exchange electronic communications by means of the Communications Network 70 and engage in brokering shipping contract. The User Interface and Communications Facilitating System 20 accepts input parameters related to a shipping service request from solicitor(s) 80 and related to a shipping service quotation from service provider(s) 90 and handles communications distribution via use of the Communications Network to solicitor(s) and service provider(s) and by submitting these parameters to the Shipping Contracting System 30 that facilitates processing steps (in the processes described below) related to proposed quotations, contract awarding to a solicitor-selected one of the proposed quotations, rejection of any non-accepted proposed quote(s) and post-awarding communications for the shipping service based on these parameters, and generates notifications and stores all the above mentioned input from solicitor(s) and service provider(s) as parameters in the Database 50 under Data Storage and Backup Facility 40. During brokering of a shipping contract, the system derives the data from the various database tables to generate reports and notifications.

As will be explained further below, the computer 10 uses the elements described above to send requests for a shipping service quote from solicitor(s) 80 to service provider(s) 90 that have been predefined or specified by the solicitor(s), receive a quote for the shipping service from service provider(s) 90, record an awarding of shipping contract and record and store post-awarding communications and digital copies of documentation. In brief, the process in the exemplary embodiment is as follows:

A solicitor 80 that has a need for shipping service enters required service details such as origin and destination address, method of delivery, delivery date, description of items, and other relevant information along with predefined provider(s) 90 details such as service provider business name and contact information, and requests a quote 100 as shown on FIG. 2. The quote request may also include a shipping service specification (e.g. door to door, door to airport, need for customs clearance, etc.) and shipment handling instructions or details (hazardous materials, special care or handling required, etc.)

The computer 10 distributes quote request 110 to each provider pre-defined in the system by the solicitor, and also stores a record of the request in the database 50. After receiving the quote request delivered via communications network 70 using one or multiple channels, such as email and/or SMS text messages (which may be offered as an optional feature as an addition or alternative to email notifications), and any updates to the request displayed via the user interface when the provider next logs into the system, each provider 90 enters a quote 120 or multiple quotes 130 for several possible routes as an offer for the requested shipping service, or the provider 90 enters no quote 140 and does not participate in bidding on the shipping request in question. Upon the computer 10 having received and stored submitted at least one quote in the database 50, the offer placement process 150 takes place by having the computer 10 generate a report containing all quotes submitted thus far for the shipping service requested and then transmit notification via communications network 70 using one or multiple channels, such as email and SMS text messages (when requested), and any updates displayed via user interface about such received quotes to the solicitor 80. In one embodiment, a new or updated report is generated and transmitted in response to each submission of a new quote, whereby a first report transmission has only a single quote for consideration by the solicitor, a second report transmission has two quotes that can be compared by the solicitor, etc.

Upon solicitor 80 receiving notifications and reviewing one or more reports containing the quote(s) for the requested service, a contract awarding process 160 takes place by having the solicitor 80 select one quote and award a shipping contract to the service provider 90 who submitted that quote, and having the computer 10 register such awarded contract in the database 50. After the contract award has been registered, the computer 10 generates and transmits notifications, including a notification transmitted to the service provider 90 whose quote has been awarded a contract 180, notification transmitted to the service provider(s) 90 whose quotes were rejected 170 and notification about the closing of bidding 190 to the service provider(s) 90 that received the request for quote, but did not participate in the bidding. Additionally, the solicitor 80 and the service provider 90 transmit to computer 10 additional information subsequently stored in the database 50 and documentation in electronic format 60 subsequently stored within data storage and backup facility 40 containing progress updates, shipment documentation and other information related to the awarded contract that can be later extracted and downloaded by either party.

With the present invention it is also possible that the solicitor 80 does not award a contract to any service provider(s) 90 who submitted the quote. In this case solicitor 80 will be able to close the request for shipping service quote without awarding a contract. For all service provider(s) 90 that have participated in submitting quotes for such shipping service quote request, the computer 10 will generate and distribute a rejection notification to the service provider(s) 90 whose quotes were effectively rejected 170 by this lack of award, and notification about closing of the bidding 190 to the service provider(s) 90 that received request for quote, but did not participated in the bidding.

In one embodiment, the timeframe for accepting of bids may be terminated only upon awarding of a contract by the solicitor. In other embodiments, the solicitor may specify an expiry date and time at which bidding is to close. In some embodiments, the solicitor is able to terminating the bid-acceptance period early by accepting a quote in any received report, or by selecting a quote request cancellation option.

Prior to service provider(s) 90 submitting a quote, the shipping contracting system 30 executes a logic that checks the parameters of the shipping quote request 100 as shown on FIG. 3, to identify if such request is not flagged by solicitor as a test request used to ensure that service provider(s) 90 can receive and respond to quote requests 210 from the solicitor, if the solicitor 80 has previously accepted terms of use 220, and if the service provider has accepted the terms of use 230. Additionally, prior to submitting a quote 260, the applicable commercial fees are indicated to service provider 240. System 30 nullifies the applicable commercial fees 250 for any test requests 210 or for any requests created by solicitor who did not accept conditions of use 220 or for any quote created by service provider who did not accept conditions of use 230.

In embodiments where the solicitor specified contact details (e.g. email address) for the providers is used to send communications to the provider, quote requests may not be received by the provider, in which case the system will notify the solicitor of the communication error (i.e. undeliverable status of the quote request), at which time the solicitor will know to retrieve updated contact information from the provider. Accordingly, the option to send a ‘test’ provides a means for the solicitor to get feedback on the provider's participation in bidding processes initiated by the solicitor. Likewise, the solicitor would be notified of an error if the provider refused to accept terms of use of the system, thereby notifying the solicitor that the particular provider in question will not be bidding on quote requests processed through the system of the present invention.

The present invention allows the service provider(s) 90 to adjust the quote price and include or partially include applicable contracting fees prior to submitting the quote. Applicable contracting fees are applied based on the parameters of the service plan defining such contracting fees for each solicitor previously inputted by an operating entity and stored in the database 50 and extracted into system 30 before further processing of the quote request 270. In other words, a contracting fee that is to be charged to a service provider for an awarded contract on a quote submitted the service provider is based at least in part upon the solicitor who requested and approved the quote.

Accordingly, the solicitors are grouped or classified into different categories or types for which different fee rates apply under a service plan administered by an administrative entity operating the system. For example, some solicitors may fall into category A, for which a contracting fee of X dollars is charged for each contract awarded by any solicitors in category A, while a greater contracting fee of Y dollars is charged for each contract awarded by any solicitor in another category B. In one exemplary embodiment, there are two classes or categories, namely a Standard Solicitor Category and a Premium Solicitor Category. An example of a standard solicitor would be a company normally operating from a single region, importing or exporting goods usually for international trade purposes, for example a Canadian-based company operating from Canada and importing goods to Canada for resale. A premium solicitor may be a large multi-national enterprise that is operating in multiple regions, importing and exporting extensively, usually for purpose of international value chain (like assembling line factories etc.), for example an automotive manufacturer exporting and importing parts to assemble their vehicles in different factories throughout the world. The Premium category will usually have higher contracting fees as they will be exposed to a better service from the operating entity and deal with larger number of service providers.

When the contract awarding process 160 is completed, the post-awarding communications process takes place as shown on FIG. 4 by where each party—solicitor 80 or awarded service provider 90—can originate the post-awarding data communication 270. Such communication contains at least one unique identifier that can be matched 280 by the computer 10 that accepts the communication, and used to look up the corresponding contract record in the database 50. If the communication is matched successfully 290, the post-awarding communication data is added to the contract record 300 and saved in the database 50. In case when such communication also contains copies of one or more documents 60 in digital format, the documents are stored in digital format in storage and backup facility 40. Whenever new post-awarding communication has been added to the contract record by one party, a communication about new update using such channels as email or text messages is sent by the communications facilitating system 20 to another party. In case when post-awarding update communication has not been matched with the relevant contract record, such communication is routed back to the originator by same communications method that it has been originally received 320.

The solicitor(s) 80 and service provider(s) 90 enter information into a database shown on FIG. 5 which is used as repository for the data relevant to shipping service quote requests, submitting quotes and related service information (e.g. delivery route, shipping ports, etc.), as well as post-awarding communications. The data input is transmitted through communications network 70 to computer 10 where the systems 20, 30 are connected to the database 50. Obtaining of data from database 50 is done through data queries lookup in various database tables. In the exemplary embodiment the Database 50 comprising plurality of database tables (could be also structured as separate databases instead of database tables). Exemplary database tables include:
User profile table(s) (1, FIG. 5): This table contains a set of user information including individual details and encrypted access credentials used to authorize such individuals representing solicitor(s) 80 and service provider(s) 90 to access user interface 20 on the centralized processing computer 10.
Solicitor master data table(s) (2, FIG. 5): This table contains a set of data about solicitor(s) 80 including contact details that they have provided, link(s) to service provider(s) 90 they have entered into the system and preferences settings used by controls within the user interface and communications facilitating system 20 and shipping contracting system 30 for pre-populating quote requests, awarded contracts and post-awarding record fields.
Service provider master data table(s) (3, FIG. 5): This table contains a set of data about service provider(s) 90 including contact details (such as those specified by the solicitor, which may subsequently be updated or revised by the service provider), information about provider's couriers and system preferences settings used by controls within the user interface and communications facilitating system 20 and shipping contracting system 30 for pre-populating quote offering, awarded contracts and post-awarding record fields.
Request details table(s) (4, FIG. 5): This table contains a set of data for shipping service quote request including a quote request identification number, a type of the shipping service, an origin location of shipment, a destination location of shipment, a shipment specification such as weight and size dimensions where applicable, a bidding ending time, a delivery date and time at or by which delivery is preferred or required, and a contract awarding status, link(s) to service provider(s) 90 in distribution list. These are used by controls within the user interface and communications facilitating system 20 and shipping contracting system 30 for communications between solicitor(s) 80 and service provider(s) 90.
Offer details table(s) (5, FIG. 5): This table contains a set of data for shipping service quote offer including an offered quote identification number, quote amount and currency, delivery route details and a pickup date and time, used by controls within the user interface and communications facilitating system 20 and shipping contracting system 30 for use in communications between service provider(s) 90 and solicitor(s) 80.
Post-awarding data table(s) (6, FIG. 5): This table contains a set of data for post-awarding communications including records of shipping progress status updates, additional instructions for shipment delivery or pickup, personal information of courier handling the goods (when applicable) and a reference link to the shipping documentation 60 stored at the data storage and backup facility. The reference links are retrieved by the user interface and communication facilitation system 20 when required to direct solicitor(s) 80 or service provider(s) 90 to the shipping documentation 60.
Accounting table(s) (7, FIG. 5): This table contains a set of data for shipping contracting fees, including fee amount, currency, applicable service plan, invoice details based on parameters previously inputted by solicitor or operating entity, and payment status used by controls within the user interface and communications facilitating system 20 and shipping contracting system 30 for invoice presentment and payment processing.
Application configuration table(s) (8, FIG. 5): This table contains a set of data for general system settings including definition of selectable time-zones, definition of selectable services (e.g. air, sea, ground), definition of packages (e.g. box, pallet, skid), dimension units, weight units, languages, translations, form template details for communications generated by user interface and communications facilitating system 20 and shipping contracting system 30.

Data storage and backup facility 40 in this present invention is configured to concurrently create a copy of the database 50 and copy of digital format files shipping documentation 60 for backup and restoration purposes. Such copies can be restored to replace original in case of failure and can be created utilizing any standard computer software for creating and maintaining backup copies.

The hardware for the described embodiment comprises of Central Processing Computer 10 that may include one or more computers setup as a server machines (e.g. firewall server, web server, application server) connected to the Communications Network 70 that is accessed using all modern technology channels (e.g. internet, cellular mobile, etc) and devices (e.g. computers, laptops, PDAs, cell phones etc.), and Data Storage Facility 40 deployed using separate computers (e.g. database server, backup server) that are connected to Central Processing Computer 10. In one embodiment, the user interface is an internet website served by the central processing computer system for access to the system by both the solicitors and providers. The central processing computer system includes computer readable memory having one or more software application stored thereon, including statement and instructions for execution by the processor(s) of one or more of the computers to execute the described processes.

The above described embodiment of the invention is meant to be representative only, as certain changes may be made therein without departing from the invention's clear teachings.

What is claimed is:

1. A system for facilitating requesting and receiving of a shipping service quote, by distributing a request from a solicitor to service providers specified by said solicitor via communication network, the system comprising:
a. a user interface which enables each of a plurality of solicitors to input parameters for a required shipping service and input information about a plurality of service providers specified by said solicitor, and enables a service provider to input parameters of a quote for the required shipping service;
b. a data storage database for storing the input parameters inputted by the solicitors and a table for the quotes inputted by the service providers;
c. a central processing computer system operating the user interface, connected with the data storage database and configured to:
i. receive a solicitor communication from each of the solicitors containing details of the required shipping service;
ii. for each of the solicitors, distribute outgoing communication to the service providers specified thereby, the outgoing communication containing the details of the required shipping service in a quote request;
iii. for each of the solicitors, receive service provider communications from the service providers containing quote details in a quote for the required shipping service; and
iv. for each of the solicitors, generate a report in which the quotes received through the service provider communications are grouped based on the details of the required shipping service previously inputted by the solicitor and distributed by the computer system.

2. The system of claim 1 where the solicitor communication and the service provider communication each contain data fields including:
a. a quote request identification number;
b. a type of the requested shipping service;
c. an origin location of the requested shipping service;
d. a destination location of the requested shipping service;
e. a shipment specification;
f. a bidding ending time by which the quotes must be submitted;
g. a pickup date and time; and
h. a delivery date and time,
and the central processing computer system generates reports with the quote requests and the quotes matched up and grouped in these reports based on at least one of said data fields.

3. The system of claim 1 where the solicitor communication contains a unique identification number for that communication and the service provider communication comprises a data field to reference the unique identification number of the solicitor communication and a central processing computer matches the service provider communication and solicitor communication on the basis of unique identification number.

4. The system of claim 1 where in the details of the required shipping service include fields for (i) shipping service specification and (ii) shipment handling instructions.

5. The system of claim 1 where the quote details include fields for (i) estimated delivery time, (ii) total price and (iii) quoting date and time and the report lists said fields for each quote.

6. The system of claim 1 in which the centralized processing computer system is connected with the data storage database, into which the centralized processing computer system stores the communications from the solicitors and the service providers.

7. A system for facilitating shipping contract awarding by communicating a contract awarding confirmation from a solicitor to a provider and facilitating post-awarding communications between the solicitor and the provider, the system comprising:
a. a data storage database containing contact details previously inputted by the solicitor and contact details previously inputted by service providers;
b. a central processing computer system connected with the data storage database and configured to:
i. record a solicitor-awarded contract based on a solicitor-selected quote from among multiple quotes received through communication from different ones of the service providers in response to a quote request from said solicitor;
ii. send notification of the solicitor-awarded contract to a one of the service providers who provided the solicitor-selected quote;
iii. send a notification of rejection to one or more of the service providers who provided a non-selected one of the quotes;
iv. send notification of bid closing to any of the service providers that were included in a list for distribution of the quote request, but did not submit a quote;
v. receive service provider communication from the one of the service providers who has been awarded the contract, the communication containing updates about the shipping service progress.

8. The system of claim 7 where the solicitor communication and the service provider communication each contain the data fields of:
a. a reference to communication unique identification number;
b. a quote request identification sequence number;
c. an offered quote identification sequence number; and
d. a contract awarding status;
and the central processing computer generates reports indicating awarded contracts based on at least those fields.

9. The system of claim 7 wherein the service provider communication contains fields for (i) date and time of delivery, (ii) full name of person who received the shipment and (iii) information about a final invoice for provided shipping service, and the centralized processing computer system distributes the service provider communication to the solicitor.

10. A system for executing shipping contracting communications between a solicitor and a service provider comprising:
a. client computer hardware and software means to enable the solicitor and the service provider to send and receive communications;
b. means to store data sets of required shipping service parameters and quotes previously and respectively inputted by the solicitor and the service provider;
c. central computer hardware and software means to:
i. receive a solicitor communication from the solicitor containing information about a required shipping service;
ii. distribute communication to solicitor-defined service providers containing details of a quote request for the required shipping service;
iii. receive service provider communications from service providers containing quotes for the required shipping service;
iv. match the service provider communications and solicitor communication on the basis of a unique identification number;
v. generate a report in which the quotes received in the service provider communications are grouped based on the details of the quote request previously inputted by the solicitors and distributed by the central computer hardware and software means;
vi. record a solicitor-awarded contract based on selection by the solicitor of one of the quotes received through the service provider communications from the service providers;
vii. send a notification of the solicitor-awarded contract to a one of the service providers whose quote was selected by the solicitor;
viii. send a notification of rejection to one or more of the service providers whose quote was not selected by the solicitor;
ix. send a notification of bid closing to any of the service providers that were included in a list for distribution of the details of the quote request, but did not submit a quote;
x. receive a post-awarding communication from the one of the service provider who has been awarded the contract, the post-awarding communication containing updates about progress of the required shipping service.

11. A method for operating a computer to execute communications necessary for requesting and receiving shipping service quotes and distributing request for shipping service quote from solicitors to service providers, the method comprising the steps of:
a. receiving a solicitor communication from a solicitor containing information about a required shipping service;
b. receiving service provider communications from the service providers, each containing details of a quote for the required shipping service;
c. generating a report notification about the received quotes upon completion of a quoting period;
d. sending a confirmation of an awarded contract as a communication to a one of the service providers whose quote was selected by the solicitor;
e. sending a notification of rejection to one or more of the service providers whose quote was not selected by the solicitor;
f. sending a notification of bid closing to at least one service provider that was included in a list for distribution of the quote request, but did not submit a quote;
g. making available a notification of shipment status and details as a post-awarding communication between the solicitor and the one of the service providers that was awarded the contract.

12. The method of claim 11 comprising the additional steps of storing the solicitor and service provider communications, and subsequently retrieving said solicitor and service provider communications before attempting to generate the report notification.

13. A method for operating a computer system to execute communications necessary for allocating the cost of contracting fees for shipping contracts awarded by solicitors to the service providers, the method comprising the steps of:
a. from an operating entity, receiving configuration parameters of a service plan applied to solicitors who have been assigned different classes, the service plan determining a contracting fee amount to be charged to a service provider for a successful quote based at least partly on a respective class of a solicitor who requested the quote;
b. making information about the contracting fee amount available to the service provider for each request for quote, where such information is:
i. made available to the service provider upon said service provider reviewing a request for quote received from the solicitor; and
ii. made available prior to the service provider submitting a quote to said solicitor in response to said request for quote.

14. The method of claim 13 comprising the additional steps of allowing the service provider to adjust the quote after reviewing the contracting fee amount and before submitting the quote to the solicitor.
